(19) United States
(12) Patent Application Publication
(10) Pub. No.: US 2025/0210803 A1
(43) Pub. Date: Jun. 26, 2025

(54) ELECTRODE ASSEMBLY

(71) Applicant: TOYOTA JIDOSHA KABUSHIKI KAISHA, Toyota-shi Aichi-ken (JP)

(72) Inventor: Mizuho MATSUMOTO, Toyota-shi Aichi-ken (JP)

(73) Assignee: TOYOTA JIDOSHA KABUSHIKI KAISHA, Toyota-shi Aichi-ken (JP)

(21) Appl. No.: 18/984,375

(22) Filed: Dec. 17, 2024

(30) Foreign Application Priority Data
Dec. 20, 2023 (JP) 2023-214456

(51) Int. Cl. H01M 50/367; H01M 4/13; H01M 50/463

(52) U.S. Cl. CPC H01M 50/367; H01M 50/463; H01M 4/13

(57) ABSTRACT

An electrode assembly includes: a first current collector; a first composite material layer; a second current collector; a second composite material layer; and a separator. The first composite material layer is provided on the first current collector. The second composite material layer is provided on the second current collector. The separator is disposed between the first composite material layer and the second composite material layer. The second composite material layer includes a groove portion. The groove portion extends along a plane direction of the first composite material layer. A ventilation portion is formed at a position that is in contact with the groove portion.

### CROSS REFERENCE TO RELATED APPLICATIONS

This nonprovisional application is based on Japanese Patent Application No. 2023-214456 filed on Dec. 20, 2023 with the Japan Patent Office, the entire contents of which are hereby incorporated by reference.

### BACKGROUND

### Field

The present disclosure relates to an electrode assembly.

### Description of the Background Art

Japanese Patent Laying-Open No. 2001-357836 discloses a battery including an electrode assembly. The battery includes an element formed by superimposing a positive electrode and a negative electrode with a separator interposed therebetween, and bonding the separator to the positive electrode and the negative electrode with an adhesive layer interposed therebetween. A groove is formed in a composite material surface of the positive electrode having the separator bonded thereto with the adhesive layer interposed therebetween, an end of the groove reaching an end side of the electrode. Japanese Patent Laying-Open No. 2001-357836 describes that a solvent volatilized from the adhesive layer for bonding the separator to the electrode is quickly discharged outside through the groove formed in the composite material surface of the electrode, which prevents the solvent from remaining in the battery.

### SUMMARY

With the use and deterioration of a battery, gas may be generated due to a side reaction in a composite material layer of an electrode assembly. The gas may stay in the composite material layer and thereby inhibit a battery reaction.

In the electrode assembly disclosed in Japanese Patent Laying-Open No. 2001-357836, gas generated on the negative electrode side when viewed from the separator cannot pass through the groove formed in the positive electrode composite material layer on the opposite side. Therefore, the gas generated within the electrode assembly may be less likely to be discharged outside.

The present disclosure has been made in view of the above-described problem, and an object of the present disclosure is to provide an electrode assembly capable of easily discharging gas generated within the electrode assembly outside.

(1) An electrode assembly according to an aspect of the present disclosure includes: a first current collector; a first composite material layer; a second current collector; a second composite material layer; and a separator. The first composite material layer is provided on the first current collector. The second composite material layer is provided on the second current collector. The separator is disposed between the first composite material layer and the second composite material layer. The second composite material layer includes a groove portion extending along a plane direction of the first composite material layer. A ventilation portion is formed at a position that is in contact with the groove portion.

According to the configuration of (1) described above, by providing the groove portion, the ventilation portion can be easily formed as described above. Through the ventilation portion, gas generated within the electrode assembly can be easily discharged outside.

(2) In the configuration of (1) described above, the groove portion may be provided such that the second current collector is exposed toward a separator side.

According to the configuration of (2) described above, a cross-sectional area of the groove portion is larger in a direction in which the groove portion extends. Thus, a flow path of the gas in the ventilation portion can be expanded.

(3) In the configuration of (2) described above, the first composite material layer may be a negative electrode composite material layer, and the second composite material layer may be a positive electrode composite material layer.

According to the configuration of (3) described above, even when the groove portion is provided such that the second current collector is exposed toward the separator side, deposition of metal such as metal lithium on the second current collector can be suppressed.

(4) In the configuration of any one of (1) to (3) described above, the separator may include, as the ventilation portion, a first ventilation portion that allows gas to flow from a first composite material layer side to a second composite material layer side.

According to the configuration of (4) described above, the gas staying in the first composite material layer moves to the groove portion through the first ventilation portion. The gas that has moved to the groove portion can further move along the groove portion. Therefore, the gas generated in the first composite material layer can be easily discharged outside.

(5) In the configuration of (4) described above, the separator may include a plurality of divided separators disposed to be arranged in the plane direction of the first composite material layer. Ends of the plurality of divided separators may be disposed at a position corresponding to the groove portion. The first ventilation portion may be the ends of the plurality of divided separators, and may be configured to allow the gas to flow from the first composite material layer side through a gap between the ends to the second composite material layer side. According to the configuration of (5), the first ventilation portion can be easily formed.

(6) In the configuration of (5) described above, the ends of the plurality of divided separators may overlap with each other.

According to the configuration of (6) described above, since the ends overlap with each other, a short circuit between the first composite material layer and the second composite material layer or the second current collector can be suppressed even when the separator includes the first ventilation portion.

(7) In the configuration of any one of (4) to (6) described above, the groove portion may extend linearly along the plane direction of the first composite material layer. The first ventilation portion may form a slit extending along the groove portion.

According to the configuration of (7) described above, a flow of the gas in the groove portion is likely to be a flow along a direction in which the groove portion extends linearly. Therefore, a direction of the flow of the gas in the groove portion is stabilized. In addition to this, a cross-sectional area of a flow path in the first ventilation portion can be expanded.

(8) In the configuration of any one of (1) to (3) described above, a second ventilation portion may be formed as the ventilation portion. The second ventilation portion may include a first portion that is a portion of the separator disposed at a position corresponding to the groove portion, and a second portion that is a portion of the first composite material layer facing the first portion. The second ventilation portion may be configured to allow gas to flow between the first portion and the second portion along a direction in which the groove portion extends.

According to the configuration of (8) described above, the gas staying in the first composite material layer can move within the second ventilation portion along the direction in which the groove portion extends. Therefore, the gas generated in the first composite material layer can be easily discharged.

(9) In the configuration of (8) described above, the separator may include a plurality of divided separators disposed to be arranged in the plane direction of the first composite material layer. Ends of the plurality of divided separators may constitute the first portion while overlapping with each other.

According to the configuration of (9) described above, at least one of the ends is easily separated from the first composite material layer. Therefore, a gap between the first portion and the second portion is likely to be ensured, and the gas can more easily flow within the second ventilation portion.

(10) In the configuration of (9) described above, the groove portion may be provided such that the second current collector is exposed toward a separator side. One of the ends of the plurality of divided separators may be welded to the second current collector.

According to the configuration of (10) described above, a flow path of the gas in the second ventilation portion can be formed more stably.

(11) In the configuration of (6) or (9) described above, portions of the ends of the plurality of divided separators overlapping with each other may be partially welded to each other.

According to the configuration of (11) described above, even when the separator includes the plurality of divided separators, a short circuit between the first composite material layer and the second composite material layer or the second current collector through the gap between the ends can be suppressed by the above-described welding.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a plan view showing an electrode assembly according to a first embodiment.

FIG. 2 is a partial cross-sectional view of the electrode assembly of FIG. 1 taken along line II-II.

FIG. 3 is a partial cross-sectional view of the electrode assembly, in which gas generated within the electrode assembly according to the first embodiment is schematically shown.

FIG. 4 is a partial cross-sectional view of an electrode assembly according to a second embodiment.

### DESCRIPTION OF THE EMBODIMENTS

Hereinafter, an electrode assembly according to each embodiment of the present disclosure will be described with reference to the drawings. In the following description of the embodiments, the same or corresponding portions in the drawings are denoted by the same reference characters, and description thereof will not be repeated.

### First Embodiment

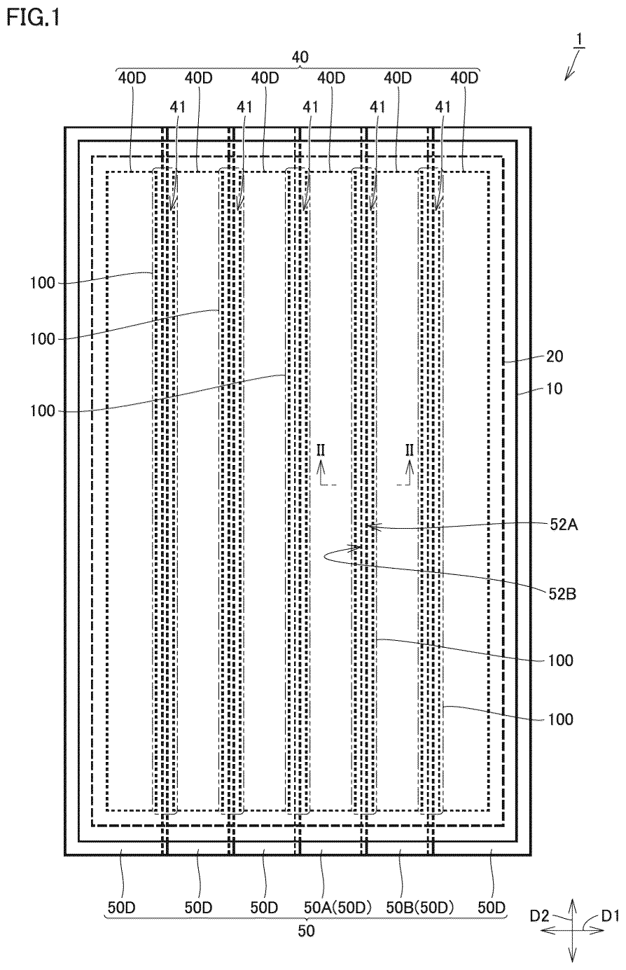

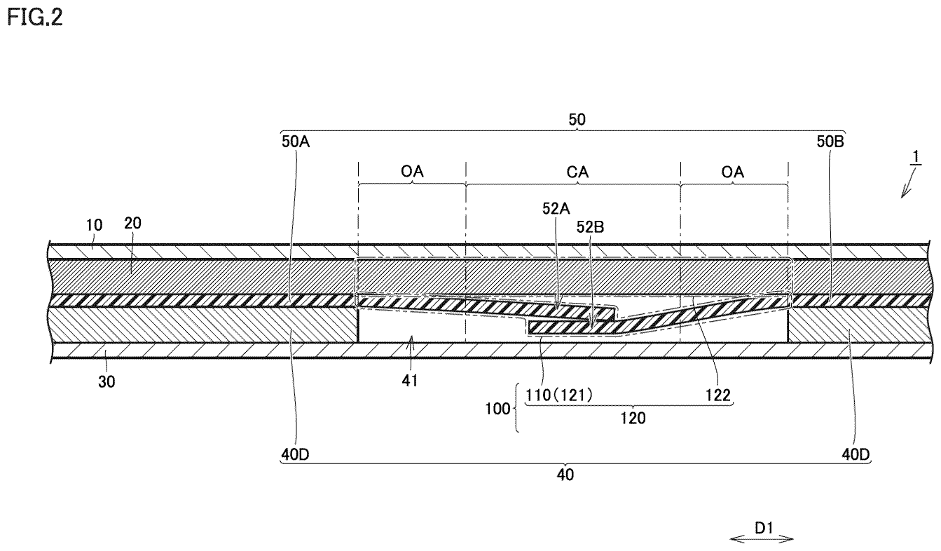

FIG. 1 is a plan view showing an electrode assembly according to a first embodiment. FIG. 2 is a partial cross-sectional view of the electrode assembly of FIG. 1 taken along line II-II.

As shown in FIGS. 1 and 2, an electrode assembly 1 includes a first current collector 10, a first composite material layer 20, a second current collector 30, a second composite material layer 40, and a separator 50. A plurality of ventilation portions 100 are formed in electrode assembly 1.

Electrode assembly 1 according to the present disclosure may be electrode assembly 1 used in a battery such as a non-aqueous electrolyte secondary battery. Electrode assembly 1 may be used in a battery in a wound state. A plurality of electrode assemblies 1 may be used in a battery in a stacked state. Electrode assembly 1 may be used in a battery in a zigzag state.

Electrode assembly 1 may be accommodated in, for example, a case (not shown) or a laminate film (not shown) having an electrolyte filled therein. Thereby, a power storage cell or a power storage device including electrode assembly 1 and the case or the laminate film may be manufactured. The power storage cell or the power storage device may be mounted on a vehicle.

As shown in FIGS. 1 and 2, first current collector 10 extends in a planar shape. First current collector 10 has a plate-like, sheet-like or foil-like outer shape. In the present embodiment, first current collector 10 has a foil-like outer shape. When viewed from a direction orthogonal to a plane direction of first current collector 10, first current collector 10 has a rectangular outer shape.

First current collector 10 is made of metal. In the present embodiment, first current collector 10 is made of copper.

First composite material layer 20 is provided on first current collector 10. First composite material layer 20 extends in a planar shape along the plane direction of first current collector 10. When viewed from a direction orthogonal to a plane direction of first composite material layer 20, first composite material layer 20 has a rectangular outer shape. The outer shape of first composite material layer 20 is along the outer shape of first current collector 10.

In the present embodiment, first composite material layer 20 is a negative electrode composite material layer. The negative electrode composite material layer includes a negative electrode active material, a binder and the like. Examples of the negative electrode active material include graphite and the like.

Second current collector 30 extends substantially parallel to first current collector 10. Second current collector 30 has a plate-like, sheet-like or foil-like outer shape. In the present embodiment, second current collector 30 has a foil-like outer shape. When viewed from a direction orthogonal to a plane direction of second current collector 30, an outer edge of second current collector 30 substantially overlaps with an outer edge of first current collector 10. Second current collector 30 has a substantially rectangular outer shape.

Second current collector 30 is made of metal. In the present embodiment, second current collector 30 is made of aluminum or an aluminum alloy.

Second composite material layer 40 is provided on second current collector 30. Second composite material layer 40 extends in a planar shape along the plane direction of first composite material layer 20. When viewed from the direction orthogonal to the plane direction of first composite material layer 20, an outer edge of second composite material layer 40 is located inside an outer edge of first composite material layer 20. Thus, when electrode assembly 1 is used in a lithium ion battery or the like, deposition of metal lithium on first current collector 10 can be suppressed.

As shown in FIG. 1, in the present embodiment, second composite material layer 40 has a plurality of groove portions 41. The plurality of groove portions 41 extend along the plane direction of first composite material layer 20. Specifically, the plurality of groove portions 41 extend linearly along the plane direction of first composite material layer 20. Thus, a flow of gas in each of groove portions 41 is likely to be a flow along a direction in which groove portion 41 extends linearly. Therefore, a direction of the flow of the gas in each of groove portions 41 is stabilized. The flow of the gas in each of groove portions 41 will be described below.

In FIG. 1, a first direction D1 and a second direction D2 are shown as the plane direction of first composite material layer 20. Second direction D2 is a direction orthogonal to first direction D1. The plurality of groove portions 41 extend parallel to second direction D2. The plurality of groove portions 41 extend from one edge to the other edge of second composite material layer 40 in second direction D2.

As shown in FIG. 2, in the present embodiment, the plurality of groove portions 41 are provided such that second current collector 30 is exposed toward the separator 50 side in each of the plurality of groove portions 41. Thus, a cross-sectional area of each of groove portions 41 is larger in the direction in which groove portion 41 extends.

Second composite material layer 40 has a plurality of divided second composite material layers 40D. The plurality of divided second composite material layers 40D are arranged in first direction D1. A pair of divided second composite material layers 40D adjacent to each other are arranged with groove portion 41 interposed therebetween.

However, groove portions 41 do not necessarily need to be provided such that second current collector 30 is exposed in each of groove portions 41. In other words, each of groove portions 41 may have a recessed strip-like outer shape that is at least opened toward the separator 50 side.

In some embodiments, only one first composite material layer 20 should be provided for the above-described plurality of divided second composite material layers 40D. This makes it possible to increase the energy density of electrode assembly 1. In some embodiments, the first composite material layer 20 should not include a groove or the like formed such that first current collector 10 is exposed at a position corresponding to each of groove portions 41. This makes it possible to increase the energy density of electrode assembly 1.

In the present embodiment, second composite material layer 40 is a positive electrode composite material layer. Thus, even when groove portions 41 are provided such that second current collector 30 is exposed toward the separator 50 side, deposition of metal such as metal lithium on second current collector 30 can be suppressed. The positive electrode composite material layer includes a positive electrode active material, a binder and the like. Examples of the positive electrode active material include LiCoO₂, LiNO₂, LiMn₂O₄ and the like. It should be noted that first composite material layer 20 may be a positive electrode composite material layer and second composite material layer 40 may be a negative electrode composite material layer.

As shown in FIG. 2, separator 50 is disposed between first composite material layer 20 and second composite material layer 40. Separator 50 separates first current collector 10 and first composite material layer 20 from second current collector 30 and second composite material layer 40. Separator 50 is made of an insulating material. Separator 50 may be a porous film. In the present embodiment, separator 50 has minute gaps that allow transmission of ions such as lithium ions.

Separator 50 includes a plurality of first ventilation portions 110 as the plurality of ventilation portions 100. Each of first ventilation portions 110 is configured to allow the gas to flow from the first composite material layer 20 side to the second composite material layer 40 side. The plurality of first ventilation portions 110 are formed at positions corresponding to the plurality of groove portions 41, respectively. Each of first ventilation portions 110 forms a slit extending along corresponding groove portion 41. Thus, a cross-sectional area of a flow path in each of first ventilation portions 110 can be expanded. A specific configuration of the slit will be described below.

In the present embodiment, separator 50 includes a plurality of divided separators 50D. The plurality of divided separators 50D are disposed to be arranged in the plane direction of first composite material layer 20. Specifically, the plurality of divided separators 50D are disposed to be arranged in first direction D1. Ends of the plurality of divided separators 50D adjacent to each other in first direction D1 overlap with each other.

Next, a pair of divided separators 50A and 50B adjacent to each other, of the plurality of divided separators 50D, will be described. A pair of divided separators 50D other than these pair of divided separators 50A and 50B may also have the same configuration as that of the pair of divided separators 50A and 50B.

In the present embodiment, ends 52A and 52B of the plurality of divided separators 50A and 50B are disposed at a position corresponding to groove portion 41. In the present embodiment, first ventilation portion 110 is specifically ends 52A and 52B of the plurality of divided separators 50A and 50B. First ventilation portion 110 is configured to allow the gas to flow from the first composite material layer 20 side through a gap between ends 52A and 52B to the second composite material layer 40 side. Thus, first ventilation portion 110 can be easily formed. The slit formed by first ventilation portion 110 is the gap between ends 52A and 52B. It should be noted that separator 50 may be formed from one member. When separator 50 is formed from one member, the slit formed by first ventilation portion 110 may be a through hole passing through separator 50.

In the present embodiment, ends 52A and 52B are located to overlap with groove portion 41 in the direction orthogonal to the plane direction of first composite material layer 20. As a result, even when a width of groove portion 41 decreases due to a change in volume of second composite material layer 40, a short circuit between first composite material layer 20 and second composite material layer 40 can be suppressed. It should be noted that edges of ends 52A and 52B may be disposed to be flush with both edges of groove portion 41 in first direction D1, respectively.

Ends 52A and 52B of the plurality of divided separators 50A and 50B overlap with each other. Since ends 52A and 52B overlap with each other as described above, a short circuit between first composite material layer 20 and second composite material layer 40 or the second current collector can be suppressed even when separator 50 has first ventilation portion 110. In addition, since ends 52A and 52B overlap with each other, at least one of ends 52A and 52B is easily separated from first composite material layer 20. However, ends 52A and 52B of the plurality of divided separators 50A and 50B may face each other in first direction D1.

In some embodiments, the overlapping portions of the plurality of divided separators 50A and 50B should be located in a central region CA of groove portion 41. This makes it possible to suppress a situation in which any one of ends 52A and 52B of divided separators 50A and 50B cannot be disposed in groove portion 41 even when a manufacturing error of the dimension of the plurality of divided separators 50A and 50B occurs. Central region CA of groove portion 41 refers to a region other than two regions OA on both sides when groove portion 41 is divided into four regions in first direction D1. It should be noted that the overlapping portions of the plurality of divided separators 50A and 50B may be located in different region OA other than central region CA of groove portion 41.

The portions of ends 52A and 52B of the plurality of divided separators 50A and 50B overlapping with each other may be partially welded to each other. As a result, even when separator 50 includes the plurality of divided separators 50A and 50B, a short circuit between first composite material layer 20 and second composite material layer 40 or second current collector 30 through the gap between ends 52A and 52B can be suppressed by the above-described welding. However, ends 52A and 52B of the plurality of divided separators 50A and 50B may partially include portions that are not welded to each other. As a result, in the overlapping portions of the plurality of divided separators 50A and 50B, the gas can flow from the first composite material layer 20 side through the gap between ends 52A and 52B to the second composite material layer 40 side.

In electrode assembly 1, the number of the plurality of divided separators 50D may be the same as the number of the plurality of divided second composite material layers 40D. As a result, the plurality of first ventilation portions 110 can be easily formed to correspond to the plurality of groove portions 41 on a one-to-one basis. Thus, discharging of the gas via groove portion 41 and first ventilation portion 110 (details will be described below) can be finely performed at a plurality of locations. The number of the plurality of divided separators 50D may be different from the number of the plurality of divided second composite material layers 40D.

Furthermore, in electrode assembly 1 according to the present embodiment, a second ventilation portion 120 is formed as ventilation portion 100. Second ventilation portion 120 includes a first portion 121 that is a portion of separator 50 disposed at a position corresponding to groove portion 41, and a second portion 122 that is a portion of first composite material layer 20 facing first portion 121. Second ventilation portion 120 is configured to allow the gas to flow between first portion 121 and second portion 122 along the direction in which groove portion 41 extends. Specifically, second ventilation portion 120 is configured to allow the gas to flow between first portion 121 and second portion 122 along second direction D2.

In the present embodiment, ends 52A and 52B of the plurality of divided separators 50A and 50B constitute first portion 121 while overlapping with each other. Specifically, first portion 121 is first ventilation portion 110.

As described above, in electrode assembly 1 according to the present embodiment, first ventilation portion 110 and second ventilation portion 120 are both formed as ventilation portion 100. However, only one of first ventilation portion 110 and second ventilation portion 120 may be formed.

For example, when no gap is formed between separator 50 and first composite material layer 20, second ventilation portion 120 is not formed. However, even in such a case, first ventilation portion 110 can be formed by causing ends 52A and 52B of the plurality of divided separators 50A and 50B constituting first ventilation portion 110 to face each other in first direction D1. In addition, in the above-described case, first ventilation portion 110 may be formed by forming separator 50 from one member and forming the above-described slit passing through separator 50.

When ends 52A and 52B of divided separators 50A and 50B are entirely welded to each other along second direction D2, for example, first ventilation portion 110 is not formed. Even in such a case, second ventilation portion 120 can be formed by causing ends 52A and 52B of divided separators 50A and 50B to overlap with each other.

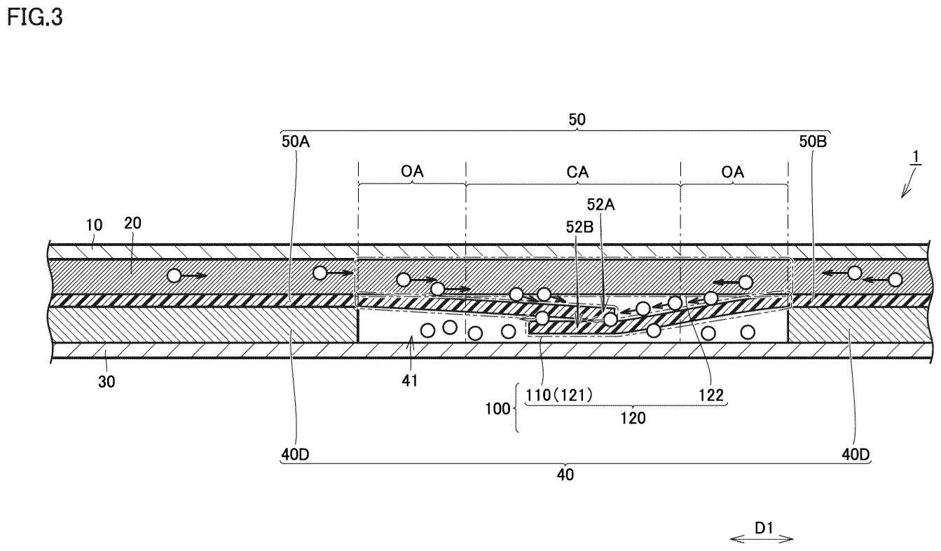

Next, the flow path of the gas when the gas is generated in first composite material layer 20 will be described. FIG. 3 is a partial cross-sectional view of the electrode assembly, in which the gas generated within the electrode assembly according to the first embodiment is schematically shown. FIG. 3 shows the electrode assembly in the same cross-sectional view as that of FIG. 2. In FIG. 3, gas G generated in first composite material layer 20 is shown. A movement direction of gas G is also schematically shown by an arrow provided to gas G.

As shown in FIG. 3, gas G generated in first composite material layer 20 stays in the gap between separator 50 and first composite material layer 20. Specifically, gas G stays in the gap between first portion 121 and second portion 122 of second ventilation portion 120. Furthermore, gas G moves to groove portion 41 through the gap between ends 52A and 52B in first ventilation portion 110. Gas G that has moved to groove portion 41 moves along second direction D2 (see FIG. 1). Then, gas G can be discharged outside electrode assembly 1 from any one of the ends of groove portion 41 in second direction D2.

Furthermore, gas G generated in first composite material layer 20 and continuing to stay in the gap between first portion 121 and second portion 122 of second ventilation portion 120 also moves in the direction along groove portion 41. That is, gas G in the gap between first portion 121 and second portion 122 also moves along second direction D2 (see FIG. 1). Then, gas G can also be discharged outside electrode assembly 1 from any one of the ends of the gap between first portion 121 and second portion 122 in second direction D2.

As described above, in electrode assembly 1 according to the first embodiment of the present disclosure, ventilation portion 100 is formed at a position that is in contact with groove portion 41.

According to the above-described configuration, by providing groove portion 41, ventilation portion 100 can be easily formed. Through ventilation portion 100, the gas generated within electrode assembly 1 can be easily discharged outside.

In addition, separator 50 includes, as ventilation portion 100, first ventilation portion 110 that allows gas to flow from a first composite material layer 20 side to a second composite material layer 40 side.

According to the above-described configuration, the gas staying in first composite material layer 20 moves to groove portion 41 through first ventilation portion 110. The gas that has moved to above-described groove portion 41 can further move along groove portion 41. Therefore, the gas generated in first composite material layer 20 can be easily discharged outside.

Furthermore, in electrode assembly 1, second ventilation portion 120 is formed as ventilation portion 100. Second ventilation portion 120 includes first portion 121 that is a portion of separator 50 disposed at a position corresponding to groove portion 41, and second portion 122 that is a portion of first composite material layer 20 facing first portion 121. Second ventilation portion 120 is configured to allow gas to flow between first portion 121 and second portion 122 along a direction in which groove portion 41 extends.

According to the above-described configuration, the gas staying in first composite material layer 20 can move within second ventilation portion 120 along the direction in which groove portion 41 extends. Therefore, the gas generated in first composite material layer 20 can be easily discharged.

### Second Embodiment

Next, an electrode assembly according to a second embodiment will be described. In the electrode assembly according to the second embodiment, divided separators are different from divided separators 50A and 50B of electrode assembly 1 according to the first embodiment. Description of the same configuration and effect as those of electrode assembly 1 according to the first embodiment will not be repeated.

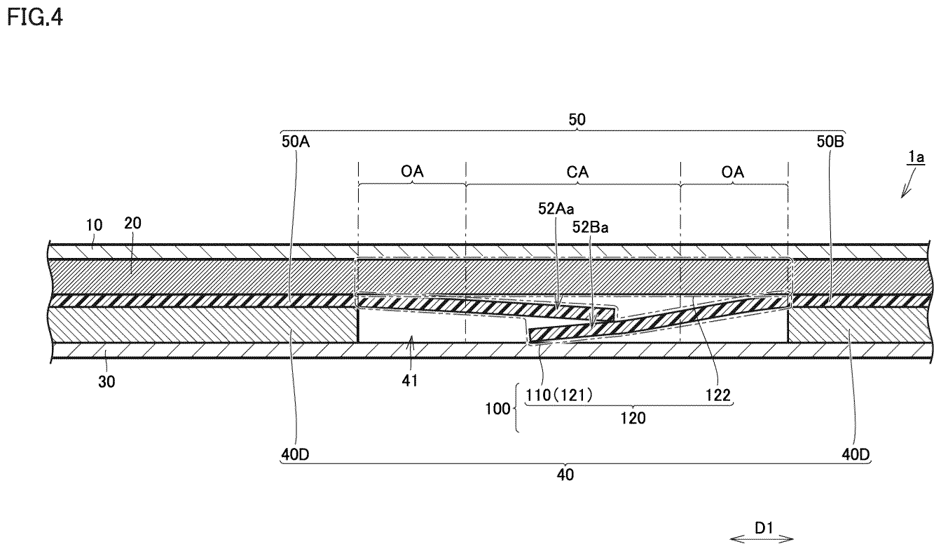

FIG. 4 is a partial cross-sectional view of the electrode assembly according to the second embodiment. FIG. 4 shows an electrode assembly 1a according to the second embodiment in the same cross-sectional view as that of electrode assembly 1 according to the first embodiment in FIG. 2.

As shown in FIG. 4, one of ends 52Aa and 52Ba of the plurality of divided separators 50A and 50B is welded to second current collector 30. According to this configuration, a short circuit between first composite material layer 20 and second current collector 30 can be further suppressed. In addition, the flow path of the gas in second ventilation portion 120 can be formed more stably. In the present embodiment, end 52Ba is welded to second current collector 30. End 52Aa may also be partially welded to second current collector 30.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. An electrode assembly comprising:
a first current collector;
a first composite material layer provided on the first current collector;
a second current collector;
a second composite material layer provided on the second current collector; and
a separator disposed between the first composite material layer and the second composite material layer, wherein
the second composite material layer includes a groove portion extending along a plane direction of the first composite material layer, and
a ventilation portion is formed at a position that is in contact with the groove portion.

2. The electrode assembly according to claim 1, wherein
the groove portion is provided such that the second current collector is exposed toward a separator side.

3. The electrode assembly according to claim 2, wherein
the first composite material layer is a negative electrode composite material layer, and
the second composite material layer is a positive electrode composite material layer.

4. The electrode assembly according to claim 1, wherein
the separator includes, as the ventilation portion, a first ventilation portion that allows gas to flow from a first composite material layer side to a second composite material layer side.

5. The electrode assembly according to claim 4, wherein
the separator includes a plurality of divided separators disposed to be arranged in the plane direction of the first composite material layer,
ends of the plurality of divided separators are disposed at a position corresponding to the groove portion, and
the first ventilation portion is the ends of the plurality of divided separators, and is configured to allow the gas to flow from the first composite material layer side through a gap between the ends to the second composite material layer side.

6. The electrode assembly according to claim 5, wherein
the ends of the plurality of divided separators overlap with each other.

7. The electrode assembly according to claim 4, wherein
the groove portion extends linearly along the plane direction of the first composite material layer, and
the first ventilation portion forms a slit extending along the groove portion.

8. The electrode assembly according to claim 1, wherein
a second ventilation portion is formed as the ventilation portion, the second ventilation portion including a first portion that is a portion of the separator disposed at a position corresponding to the groove portion, and a second portion that is a portion of the first composite material layer facing the first portion, and
the second ventilation portion is configured to allow gas to flow between the first portion and the second portion along a direction in which the groove portion extends.

9. The electrode assembly according to claim 8, wherein
the separator includes a plurality of divided separators disposed to be arranged in the plane direction of the first composite material layer, and
ends of the plurality of divided separators constitute the first portion while overlapping with each other.

10. The electrode assembly according to claim 9, wherein
the groove portion is provided such that the second current collector is exposed toward a separator side, and
one of the ends of the plurality of divided separators is welded to the second current collector.

11. The electrode assembly according to claim 6, wherein
portions of the ends of the plurality of divided separators overlapping with each other are partially welded to each other.

12. The electrode assembly according to claim 9, wherein
portions of the ends of the plurality of divided separators overlapping with each other are partially welded to each other.
